(19) United States
(12) Patent Application Publication
(10) Pub. No.: US 2014/0088945 A1
(43) Pub. Date: Mar. 27, 2014

(54) SYSTEM AND METHOD FOR AN ENERGY MANAGEMENT SYSTEM

(71) Applicant: American Energy Assets, LLC, Denver, CO (US)

(72) Inventors: Jack Davis, Denver, CO (US); James Kobbe, Aurora, CO (US); Dan Weller, Denver, CO (US); Andrew Gertz, Denver, CO (US)

(73) Assignee: American Energy Assets, LLC, Denver, CO (US)

(21) Appl. No.: 14/033,232

(22) Filed: Sep. 20, 2013

Related U.S. Application Data
(60) Provisional application No. 61/703,669, filed on Sep. 20, 2012.

(51) Int. Cl. G06F 17/50

(52) U.S. Cl. CPC G06F 17/5009
USPC 703/13

(57) ABSTRACT

Implementations of the present disclosure involve a system and/or method for analyzing the energy efficiency of a building. The system receives a set of data points from a building automation system operating to control various aspects of the building. The data points each corresponds to an environmental condition of the building. Each data point is associated with a variable that represents the represents a type of information conveyed by the data point. Variables are then mapped to component models that represent the physical components of the building. A formula is then selected for evaluating the operation of one or more physical components. Building problems are then diagnosed by evaluating the formula using the data points.

### CROSS REFERENCE TO RELATED APPLICATION

Aspects of the present disclosure take advantage of and are described in U.S. provisional application No. 61/703,669, titled “Energy Management System,” filed on Sep. 20, 2012, the disclosure of which is hereby incorporated by reference.

### FIELD OF THE DISCLOSURE

Aspects of the present disclosure involve retrieving datasets, mapping the datasets to components to generate a model, and analyzing the models. More particularly, the present disclosure involves gathering information from a building automation system and using the collected data points to automatically model the building. The model is then used in conjunction with the acquired data points to identify opportunities to increase building efficiency.

### BACKGROUND

As electronics have proliferated throughout everyday equipment, the amount of data being generated and collected has greatly increased yielding new opportunities for utilizing the data. Data may be aggregated from a variety of sources and then analyzed to paint a detailed picture of a system or situation.

For example, the number of electronic sensors and controls in modern buildings has greatly increased over the years. Modern and modernized commercial buildings are generally equipped with computer controlled building automation systems (BAS) that are capable of monitoring, controlling, and optimizing a building's environment. A BAS may be capable of controlling and monitoring a building's mechanical and electrical equipment, such as the building's heating, ventilation, and air conditioning (HVAC) systems, lighting systems, power systems, fire systems, security systems, and any other electromechanical systems present in the building. A properly configured and functioning BAS is essential for maintaining building comfort and safety while also conserving energy and maximizing building efficiency. The BAS may include software running on one or more computers or servers that are connected to various networking devices, sensors, HVAC controls, and any control systems for building functions.

In order to analyze the BAS and associated building or structure, a model of the building components is first generated. The process of creating a building model is often very tedious and time consuming. A method for quickly and easily generating a building model is needed as well as a more advance system for analyzing a building. It is with these issues and problems in mind, amongst others, that various aspects of the present disclosure were developed.

### SUMMARY

Implementations of the present disclosure involve a system and/or method for analyzing building data accumulated by a building automation system. The system/method receives data points from a building automation system and uses the data points to populate corresponding variables. The variables are then mapped to component models and a building model is generated. The building model is then used for analyzing the building and building automation system. Depending on the component models in the building, various formulae may be selected to evaluate the operation of the components and building as a whole. The results of the evaluation may then be used to diagnose problems with the building's various systems.

### BRIEF DESCRIPTION OF THE FIGURES

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 depicts a building and HVAC system that utilizes a building automation system (BAS).

FIG. 2 depicts an operating environment of an example energy management system.

FIG. 3 depicts a method of automatically gathering data points and using the data points to identify inefficiencies.

FIGS. 4A and 4B depicts an example output of the system displaying energy usage and potential savings.

FIG. 5 depicts a method of mapping data points to model components to build a model of a building.

FIG. 6 depicts a method of evaluating the efficiency of a building.

FIG. 7 depicts a more detailed embodiment of the energy management system.

FIG. 8 is an exemplary computing system for implementing various aspects of the systems and methods described herein.

### DETAILED DESCRIPTION

Aspects of the present disclosure involve analyzing the operation of a source system by receiving data points from the source system and/or any additional data sources, mapping the data points to corresponding variables, and producing a virtual model by mapping the variables to component models. The virtual model is then used to perform analysis on the functionality of the source system. More particularly, the present disclosure involves analyzing building equipment by receiving data points from a building automation system (BAS) and/or directly from building sensors/components, as well as from outside sources. The acquired data points are then used to populate corresponding variables, which are in-turn mapped to component models. The component models are then used to form a building model and building analysis may be accomplished. The analysis may be related to identifying problems or inefficiencies in a building's HVAC or other systems and deriving a cost associated with the problem.

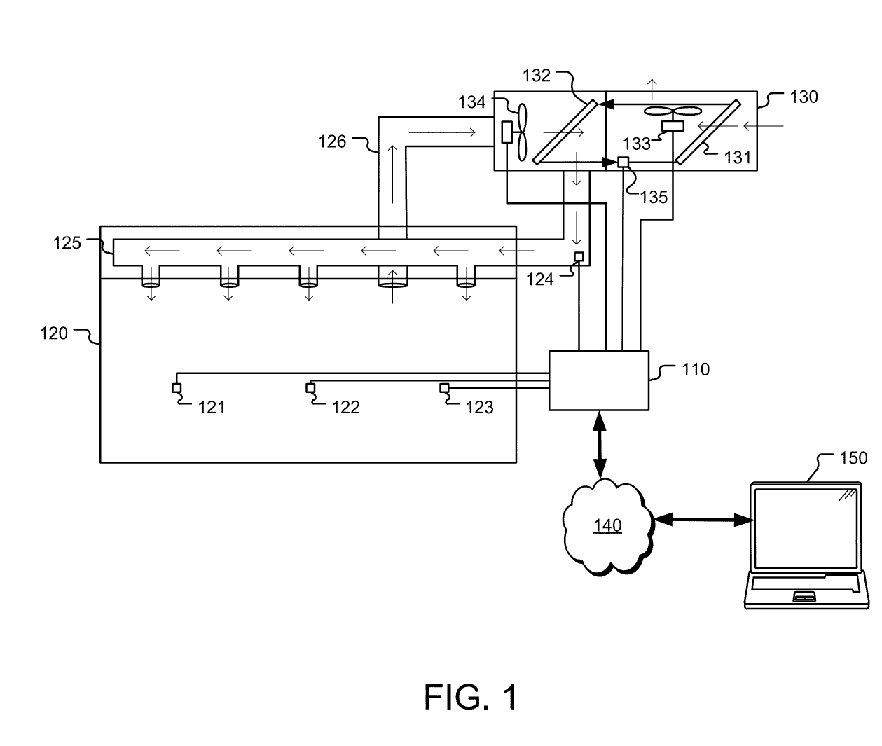

FIG. 1 depicts an example building and HVAC system controlled by a BAS. The building 110 may include any type building including an office building, retail building, a hospital, a low-rise/mid-rise/high rise building, a home, a school, a sports complex, an apartment building, etc. The building 110 may also include a plurality of buildings, complexes, etc. In general, the use of the word “building” herein may refer to any type of enclosed or partially enclosed structure.

The HVAC system 130 provides the building 120 with hot or cold air through an inflow duct 125. Air is returned to the HVAC system 130 via an outflow duct 126. The example HVAC system 130 includes two fans 133, 134 positioned to cause air to flow across two radiators 131, 132. Water or other liquid is pumped between the two radiators 131, 132 by the pump 135. In practice, the cool air is pulled across the first radiator 131, causing the water to be cooled. The water may then be pumped into the second radiator 132 which has warm air from the building pumped across it. The building air is cooled as it crosses the radiator and pushed back into the building 120 via the inflow duct 125. It should be understood that this is a simplified example of a HVAC system being used for illustrative purposes and that there are many potential types of HVAC systems. The present disclosure is not limited by the type of HVAC system used by a building.

A BAS 110 is connected to various points in the building 120 and HVAC system 130. For example, the building 120 may include a variety of sensors 121-123 for measuring the temperature and humidity at various locations inside of the building 120. In one example, the sensors 121-123 may include thermostats. The HVAC system 130 may also include various sensors and the various components in the HVAC system 130 may provide an output related to their status. In this example, the BAS 110 is connected to the temperature and humidity sensors 121-124 placed within the building 120 and HVAC system 130. The BAS 110 is also connected to the fans 133, 134 and the pump 135 and is able to control each component in the HVAC system 130 as well as retrieve a current status of each component. Thus, the BAS 110 is capable of controlling the building's 120 temperature by adjusting the output of the HVAC system 130 through the fans 133, 134, and pump 135 of the HVAC system 130 in response to the outputs of the sensors 121-124. In one embodiment, the BAS 110 is also connected to a network 140. A user may connect to the BAS 110 using a computing device 150 such as a personal or laptop computer to interface with the BAS, such as to retrieve data from the BAS or adjust the settings of the BAS.

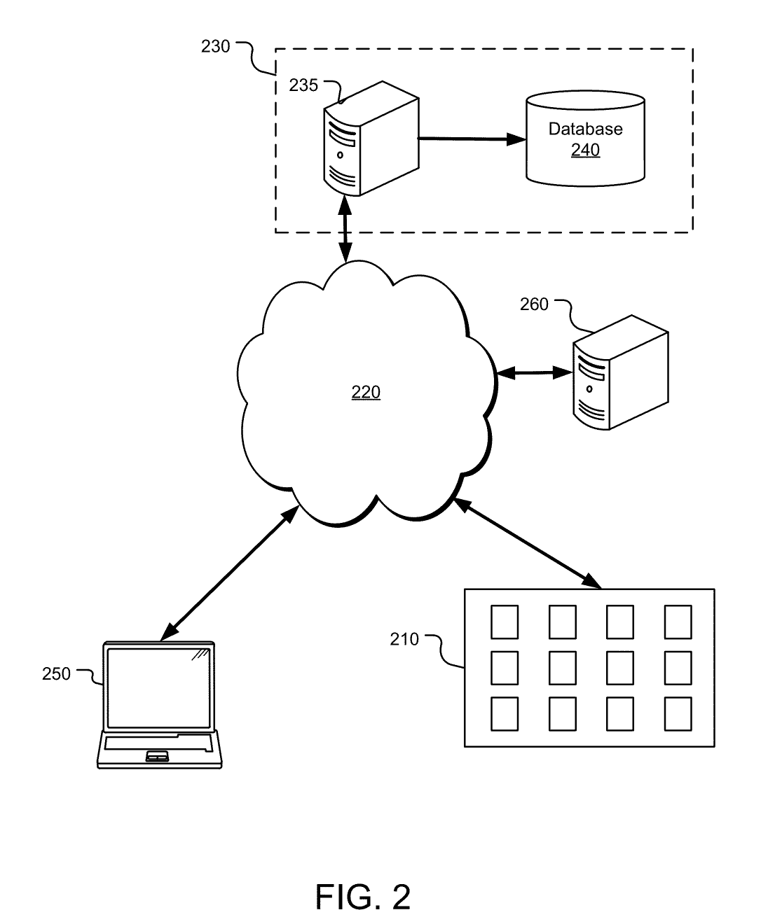

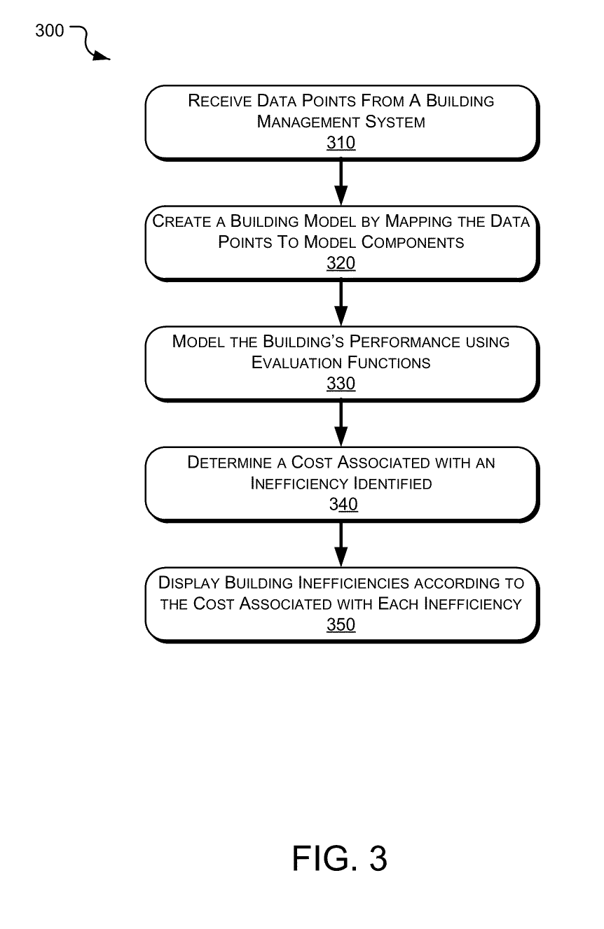

Referring now to FIGS. 2 and 3, an example energy management system and method of analyzing a building are depicted. A source system 210, such as the building described with respect to FIG. 1, includes a variety of systems connect to a BAS. The BAS collects data points from each building system and/or sensor. These data points are sent over the network 220 to an energy management system 230 for analysis (operation 310). The energy management system 230 may be configured to automatically download the data points from the source system 210 as well as from any other appropriate source, including additional systems, sensors, websites, and servers (collectively “data sources”). The energy management system 230 may include a server 235 for receiving data and performing analysis, as well as a database 240 for storing the data points, information for modeling buildings, and functions for analyzing buildings.

The energy management system 230 may connect to the data sources using any type of network 220. In one example, the energy management system 230 may connect to the data sources using the Internet and any suitable transfer method, such as FTP, SSH, HTTP, HTTPS, or combination of transfer methods. In another example, the energy management system 230 may receive data points from a portable storage device such as a USB flash drive, CD, DVD, Blu-ray Disc™, portable hard drive, or any other type of electronic storage device. The energy management system 230 may also be capable of parsing information from a website to retrieve the data points. For example, the energy management system 230 may retrieve data points from weather or utility servers or websites. The energy management system 230 may also parse the text of websites and filter unneeded information if the desired data points are not directly available. All of these data points may be stored in the database 240 and may be grouped according to their source and normalized, if necessary.

The data points may include any real world data that is relevant for describing and/or analyzing the source system 210. The data points may be captured by one or more components using various sensors and status outputs, and may be stored on the source system 210 or on an external storage system connected to the source system 210 along with a timestamp indicating when the data point was collected. In one example, the data points may be grouped as variables according to the data source/sensor that captured or compiled the data points. The data points may be stored in one or more data files on the source system 210, on a server, on a storage system, a personal computer, or the like. The data points may also be aggregated into a single database organized according to the data source. For example, a BAS 110 associated with the source system 210 may collect data points from temperature and humidity sensors 121-123, including current temperature, target temperature, and humidity within the source system 210. The BAS 110 may also collect data points from the HVAC system 130 of the source system 210, including input air temperature, output air temperature, and fan speed. The data points collected at each temperature/humidity sensor may be grouped or linked together while the data points collected by the HVAC system 130 may also be grouped or linked together. Furthermore, both sets of data points may also be grouped together based on their association within the BAS 110.

Once the data points are collected, the energy management system 230 then constructs a building model by using the data points to populate variables and by mapping the variables to component models (operation 320). The component models include at least one variable associated with the model and may represent a generic component. The generic component model may include each possible data point that may be collected by the type of component, including variables that aren't captured by the source system. For example, a generic component model for an air handler may include variables for intake air temperature, output air temperature, humidity, cold and hot water temperature, one or more valve statuses, and a fan speed. During data mapping, the energy management system 230 may receive a set of data points that includes intake air temperature, output air temperature, and fan speed. The energy management system 230 recognizes that these variables are associated with an air handler, and if no specific air handler models in the database 240 correspond to these variables, maps the variables to the generic air handler component model.

In another example, some or all of the generic component models may be replaced with specific component models. In this case, a user or an administrator may manually identify each component present in the source system 230 and manually map the variables. The user/administrator may also have the option of manually mapping groups of variables or specific variables to specific component models and/or generic component models, or rely on the automated system. For example, the source system 210 may include two or more similar components. If the energy management system is unable to resolve which variables should be mapped to which component model, then a user may manually designate how the variables should be mapped.

Once the data points have been mapped to the various component models, the energy management system may select one or more functions to be used to evaluate the source system 210 and the source systems components (operation 330). The functions are configured to evaluate the performance of various component models and/or combination of component models in the building model and identify areas where the building is not operating at peak efficiency. Specifically, the energy management system automatically selects functions to use to evaluate the operation of the building according to a building model.

A function may for example include variables that are populated using the data points, as well as system conditions or outputs. For example, data points for temperature and humidity collected by temperature and humidity sensors 121-123 may each be compared to each other. If the temperature at one of the sensors is outside of a difference threshold, then there may be an issue at the location of the offending sensor. For example, the HVAC system may be not supplying the location of the offending sensor with enough hot or cold air, or the sensor may be malfunctioning, causing the HVAC system to needless supply the location with too much hot or cold air. In another example function, the temperature at a location may be compared when the fans 131, 132 are operating and when they are not operating. Large changes in temperature may signify an issue related to air/heat/cold escaping from the location and signify the need to add insulation, change weather stripping, replace windows, or the like.

The functions used for any one component may be modified and a user or administrator may select additional functions to associate with the component. A user or administrator may also create new functions specifically for the analysis of the source system 210. The functions include arithmetic functions, Boolean functions, and functions that are a combination of arithmetic and Boolean functions. For example, a function may include only variables or be a function of one or more variables compared to upper limits, lower limits, and/or various other conditions or thresholds. Furthermore, functions may be implemented that update and utilize historical data, such as averages and standard deviations. The functions may use any variables supplied by any of the data sources as well as variables generated using the provided variables.

The results generated by evaluating the functions are then used to determine a cost associated with an inefficiency (operation 340). Hardware failures, software failures, inefficient control sequences, and/or poor operating strategies may introduce inefficiencies that lead to extra energy costs. For example, the energy management system 230 may identify an improperly operating fan in the building's HVAC system. The additional energy cost associated with the improperly operating fan may then be calculated amongst other energy related metrics. The energy management system 230 may then display the results of the analysis (operation 350). The results may be displayed on a website hosted or updated by the energy management system 230. A user may then access the results using a computing device 250, such as a laptop, personal computer, tablet computer, smart phone, or other computing device. The results of the analysis may be displayed as raw data, in table form, or graphically, and may include historical results and average results. The results also may include an estimated cost to rectify the inefficiency, for example, the cost to replace a component.

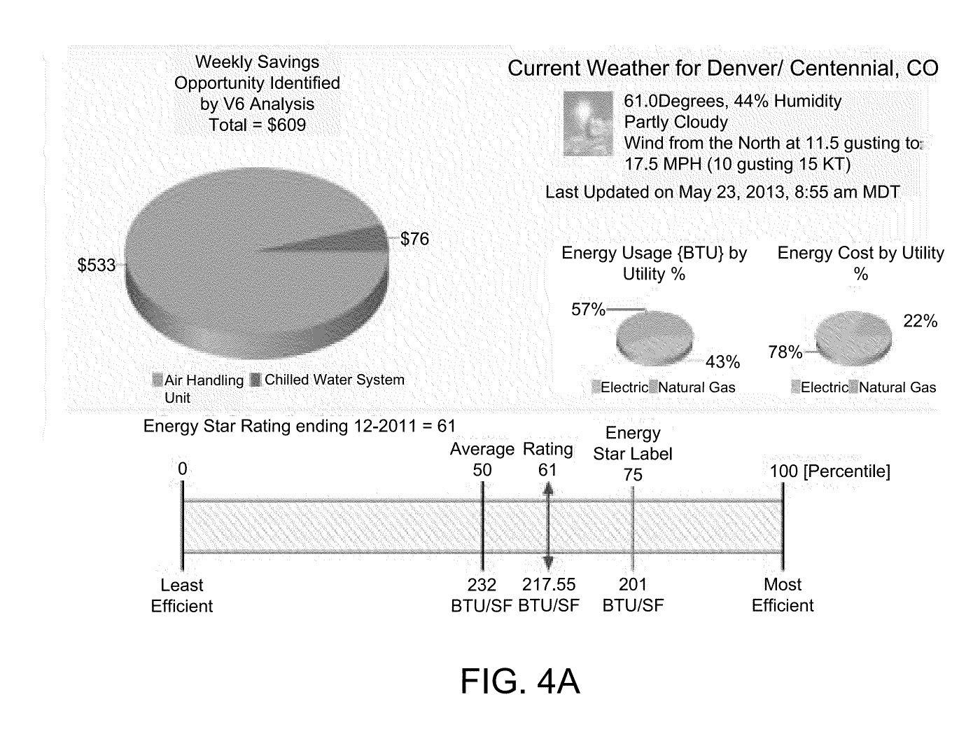

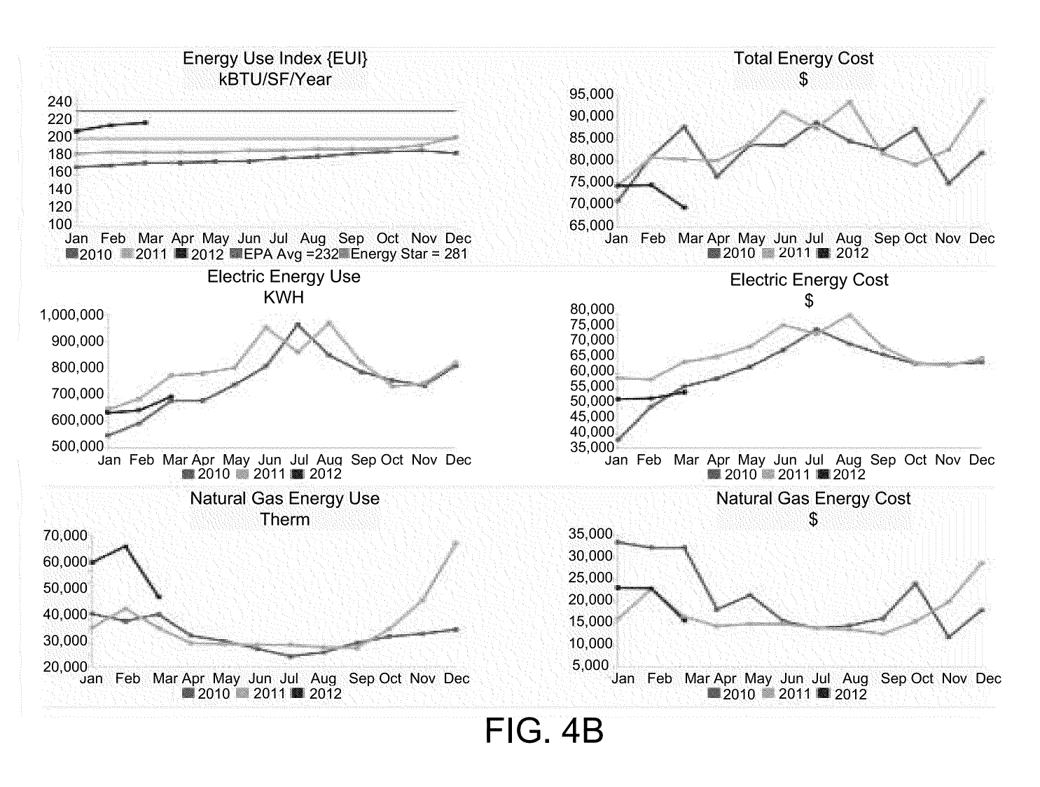

Referring to FIGS. 4A and 4B, an example output of the results of the analysis is depicted. In this example, a pie chart depicts the weekly savings opportunity that is available by fixing the BAS or building, and additional pie charts display the energy usage and cost by utility type. An energy star rating that compares the results against peers is also displayed. Graphs may also be generated with current and past data. In this example, line graphs showing a month-by-month energy use index, a total energy cost, electrical energy usage, electrical energy cost, natural case energy usage, and natural gas energy are depicted.

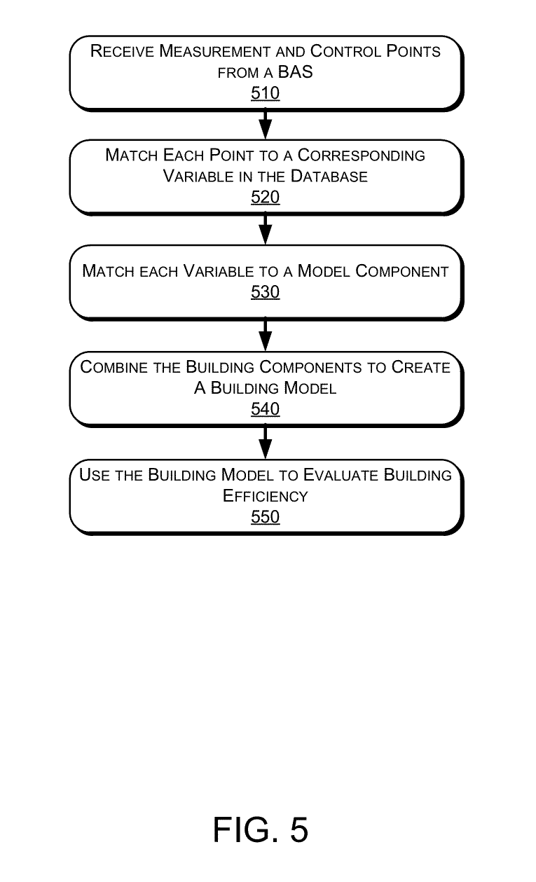

Referring now to FIG. 5, a flow chart detailing the mapping of data points to produce a building model is depicted. As described above, the energy management system receives a plurality of data points representing measurements and control information from a BAS (operation 510). Each of the data points is mapped to a corresponding variable in the database (operation 520). Groups of variables are then matched to model components (operation 530). For example, the data points collected from a thermostat may include current temperature, set temperature, and humidity. The system receives a set of data points corresponding to the current temperature, set temperature, and humidity at the thermostat. Although the data points received are values, the data points are mapped to variables corresponding to what the measurements are of. For example, the actual values for temperature and humidity are not used for mapping the data points to a component, but the data points are mapped to variables for a current temperature, a set temperature, and humidity. The energy management system then identifies a component model that uses at least the three variables. Thus, when a building is being modeled, the actual values of the data points may be disregarded by the system. Conversely, when the system is analyzing the building, the variables are populated with the data points so that the functions may be evaluated. Once all of the building components have been identified, the building model is complete (operation 540). The building model may then be used to select functions to evaluate the energy efficiency and performance of the building (operation 550).

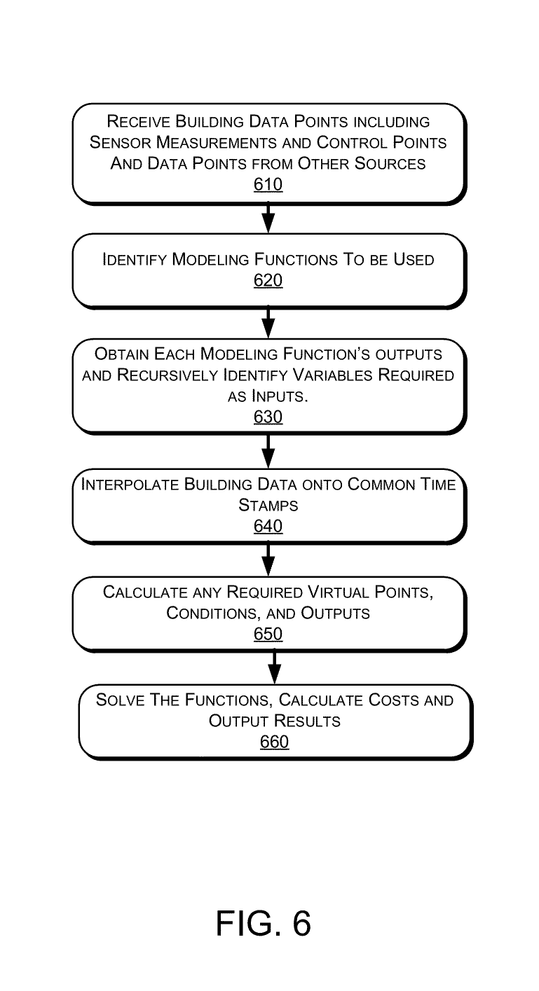

FIG. 6 depicts a method of evaluating a dataset using one or more functions. Specifically, once a building has been modeled, the energy management system may periodically retrieve data points from the building's BAS and other data sources, and evaluate the efficiency of the building. The building may be evaluated on a daily, weekly, monthly or other basis using system selected and/or user selected functions. Such functions may be selected based on any number and type of criteria. For example, a user may wish to determine the efficiency of a building during peak and/or off-peak operating hours of the business occupying the building. Thus, the user may select functions that obtain an analysis of the energy usage of the building for the specific timeframe around the peak and/or off-peak operating hours. Other criteria may include selecting specific instances to perform a test, such as the HVAC system's energy usage during a hot or cold day. The system would run the analysis if an outside temperature exceeds or is below a temperature threshold.

At the prescribed interval, the energy management system receives data points from the building's BAS and retrieves additional data points from the various other data sources (operation 610). The energy management system may then automatically identify the functions that will be evaluated according to the building model (operation 620). A user may have the option to review the functions selected and may add or remove functions. The system may operate in a recursive manner in determining if all of the variables needed to evaluate each function are provided or obtained.

Before the functions may be evaluated, the variables required by the functions may be analyzed to ensure that the system has enough information to evaluate the functions. In particular, the energy management system identifies the outputs that the system is solving for and then recursively identifies the variables required to solve the functions that produce the outputs (operation 630). For example, the system may select a function for testing a component that outputs an efficiency rating. The function for calculating the efficiency rating may include a number of variables, and one or more of the variables may be dependent on one or more other variables. Thus, the system starts with the desired output and recursively finds the variables needed to calculate the output and any variables needed to populate any dependent variables.

The system also analyzes the data points to ensure that they all correspond to the same timestamp. In many cases, the timestamp of each data point may not be the same. For example, the BAS may log the temperature at a thermostat every 15 minutes, but when the data points are harvested, the BAS may have real time data for another data point, such as a fan speed. Thus, the timestamp for the temperature data point may be up to fifteen minutes before the timestamp for the fan speed data point. Thus, depending on the components being used and a BAS's configuration, there may be some variance in the timestamps provided. The system may interpolate the data points onto a common time stamp to accommodate the variance in the timestamps (operation 640).

Variables that were not populated by the data points, but useful for the selected functions, may be solved for before evaluating the functions (operation 650). These variables may include virtual data points, system and output conditions, and costs. Virtual data points are calculated using one or more other data points, a default value, or a user selected value. For example, a BAS may provide an input air temperature, an output air temperature, and a fan speed of an air handler. Using the provided data points, the system may calculate virtual data points for input water temperature, output water temperature, active chiller load percentage, and instantaneous power usage. In other cases, it may be unnecessary to calculate a virtual point because a default or user selected value was provided. For example, the input water temperature of a HVAC system may be a standard temperature for a specific model. Thus, the standard input water temperature may be set as a default value or provided by a user. The system may then use the virtual data points in conjunction with the provided data points to evaluate the functions.

Some functions may also use information related to system and output conditions. System and output conditions are conditions that relate to the current state or output of the system. Both system and output conditions are represented by Boolean values signifying if the condition is true. For example, a valve in an HVAC system may be pressure activated and not connected to the BAS. Thus, there is no data point provided relating to whether the valve is opened or closed. System and output conditions are calculated by using the provided data points. Thus, the state of the valve may be calculated using other data points, such as a pressure reading at the location of the valve.

Similar to system conditions, output values may also be used by the functions. An output condition may relate to the presence of any system output. For example, an output condition at a location may include whether a HVAC system is providing heating. Output conditions may also be determined by evaluating data points. For example, the system may compare the temperature at a location across a period of time. If the location is getting warmer despite an outside temperature being the same or colder, then the HVAC system is outputting heat.

System and output conditions may be used in condition statement-based formula. With condition-based formulas, the result is calculated by solving a formula associated with the matching condition statement. Thus, two different formulas may be utilized depending on the state of a system or output condition. For example, if an output is condition one (Boolean true), then formula one is used with the variable. If the output is condition two (Boolean false), then formula two is used with the variable. For example, if the HVAC system is providing heating at a location, then formula one is used. Otherwise formula two is used.

Once all of the required virtual points, conditions, and outputs have been determined, the system may evaluate each function. The system may then calculate energy and dollar values related to the result of the function and output the results (operation 660).

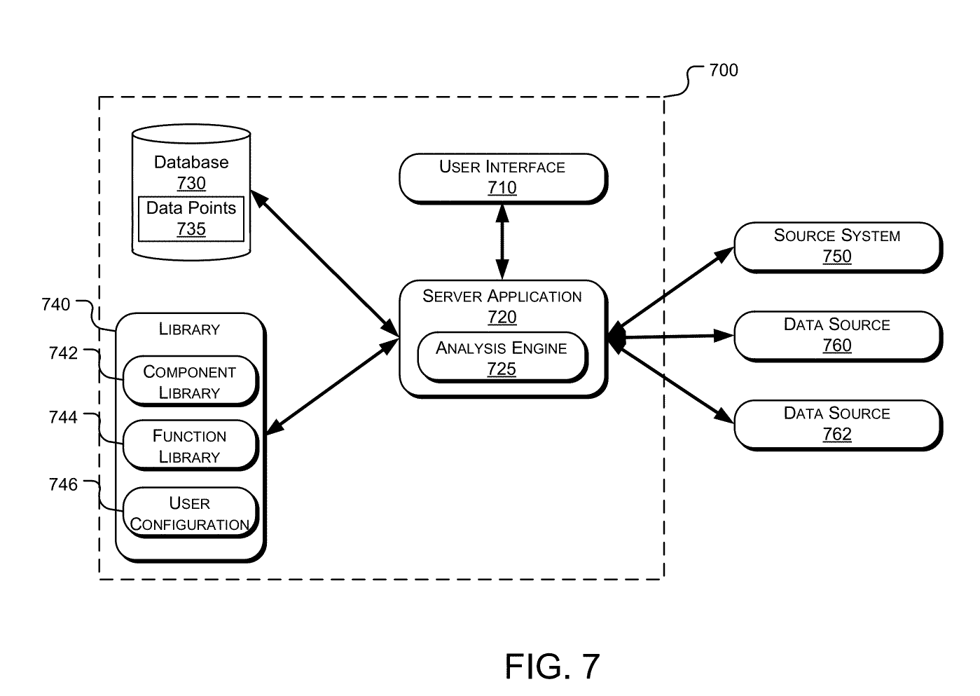

Referring to FIG. 7, an example energy management system 700 is depicted. The energy management system 700 includes four subsystems, including a user interface 710, a server application 720, a database 730, and a library 740. The user interface 710 may be accessed directly at a server operating the energy management system 700, or may be accessed remotely using a computing device. The user interface 710 is configured to receive any user input for the configuration of the energy management system 700, as well as display any system information and results. In one example, the user interface 710 may operate as a webpage that is accessible by the user using a network connected computing device. The server application 720 is configured to receive data points from the source system 750 and other data sources 760, 762 and to store the data points 735 in the database 730. The server application is also configured to retrieve the data points 735 from the database 730 as well as component models, functions, and user configurations from the library 740. The analysis engine 725 may use the data points 735 in conjunction with the component library 742 to build a building model in conjunction with a user configuration 746 as described above. The building model may also be stored in the database 730. The analysis engine 725 may also use the data points, the building model, and various functions from the function library 744 to analyze the data points. The results may then be added to the data points 735 and made accessible to the user interface 710.

The user interface 710 may include a computer application configured to allow for the setup and configuration of the energy management system 700 and for displaying the output of the energy management system 700. The user interface may, for example, be an application operating on a remote user computer or a web application accessible by a web browser.

The server application 720 interfaces with the user interface 710, the database 730, the library 740, and retrieves data from the source system 750 and other data sources 760, 762. The server application 720 may retrieve data points from the source system 750 and data sources 760, 762 by utilizing a network such as the Internet, as described above. Data points retrieved by the server application 720 may be appropriately sorted, grouped, and stored in database 730. When conducting analysis the server application 720 retrieves the data points 735 along with a stored building model from the database 730 and utilizes functions stored in the function library 744 to conduct the building analysis using the analysis engine 725.

The analysis engine 725 may be configured to map data points to model components along with completing all of the calculations needed to analyze the data points 725. The analysis may include solving for any virtual points, conditions, and outputs as describe above, along with evaluating the functions using the data points 725. After the analysis engine 725 has completed the analysis engine may provide the user interface with the results of the analysis.

The database 730 is configured to store the collected and calculated data points 635 as well as any components mapped to a building and functions used for evaluating the building. The database 730 may group the data points 735 according to the source of the data points 735 or any other relationship between data points.

The library 740 includes model components, functions, and user configurations used to define the analysis conducted by the energy management system 700. The library 740 may also be stored in the database 730. The component library 742 includes each of the model components including both generic and specific models. The formula library 744 includes all of the formulas used for analysis along with associations between the formula and each model component and groups of model components. The user configuration file includes any system information, values, data, or requirements specified by a user.

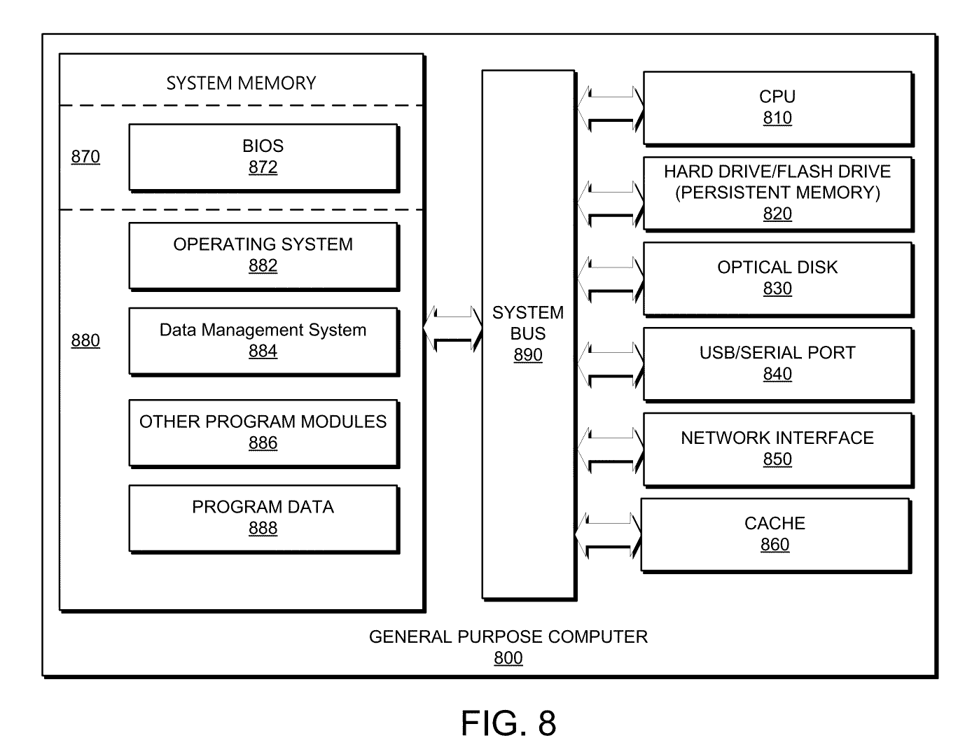

FIG. 8 illustrates an example general purpose computer 800 that may be useful in implementing the described technology. The example hardware and operating environment of FIG. 8 for implementing the described technology includes a general purpose computing device in the form of a personal computer, server, or other type of computing device. In the implementation of FIG. 8 for example, the general purpose computer 800 includes a processor 810, a cache 860, a system memory 870, 880, and a system bus 890 that operatively couples various system components including the cache 860 and the system memory 870, 880 to the processor 810. There may be only one or there may be more than one processor 810, such that the processor of the general purpose computer 800 comprises a single central processing unit (CPU), or a plurality of processing units, commonly referred to as a parallel processing environment. The general purpose computer 800 may be a conventional computer, a distributed computer, or any other type of computer; the invention is not so limited.

The system bus 890 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 870 and random access memory (RAM) 880. A basic input/output system (BIOS) 872 containing the basic routines that help to transfer information between elements within the general purpose computer 800 such as during startup is stored in ROM 870. The general purpose computer 800 further includes one or more hard disk drives or flash-based drives 820 for reading from and writing to a non-transitory persistent memory such as a hard disk, a flash-based drive, and an optical disk drive 830 for reading from or writing to a removable optical disk such as a CD ROM, DVD, or other optical media.

The hard disk drive 820 and optical disk drive 830 are connected to the system bus 890. The drives and their associated computer-readable media provide nonvolatile storage of computer-readable instructions, data structures, program engines and other data for the general purpose computer 800. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk 820, optical disk 830, ROM 870, or RAM 880, including an operating system 882, an energy management system 884 such as the one described above, one or more application programs 886, and program data 888. A user may enter commands and information into the general purpose computer 800 through input devices such as a keyboard and pointing device connected to the USB or Serial Port 840. These and other input devices are often connected to the processor 810 through the USB/serial port interface 840 that is coupled to the system bus 890, but may be connected by other interfaces, such as a parallel port. A monitor or other type of display device may also be connected to the system bus 890 via an interface, such as a video adapter 860. In addition to the monitor, computers typically include other peripheral output devices (not shown), such as speakers and printers.

The general purpose computer 800 may operate in a networked environment using logical connections to one or more remote computers. These logical connections are achieved by a network interface 850 coupled to or a part of the general purpose computer 800; the invention is not limited to a particular type of communications device. The remote computer may be another computer, a server, a router, a network PC, a client, a peer device, and typically includes many or all of the elements described above relative to the n general purpose computer 800. The logical connections include a local-area network (LAN) a wide-area network (WAN), or any other network. Such networking environments are commonplace in office networks, enterprise-wide computer networks, intranets and the Internet, which are all types of networks.

The network adapter 850, which may be internal or external, is connected to the system bus 890. In a networked environment, programs depicted relative to the general purpose computer 800, or portions thereof, may be stored in the remote memory storage device. It is appreciated that the network connections shown are example and other means of and communications devices for establishing a communications link between the computers may be used.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

1. A method of analyzing the energy efficiency of a building comprising:
receiving a set of data points from a building automation system operating on the building, wherein each data point corresponds to an environmental condition of the building;
associating each data point with a variable representing a type of information conveyed by the data point;
mapping at least one variable to a component model, the component model representing a physical component of the building;
selecting a formula for evaluating the operation of the physical component represented by the component model; and
diagnosing an environmental condition of the building by evaluating the formula using the data points.

2. The method of claim 1, wherein the set of data points is divided into at least one group of data points according to a relationship between at least two data points, and wherein a group of data points is associated with a group of variables and the group of variables is matched to a single component model.

3. The method of claim 2, wherein at least one data point is generated by a sensor component operating within the building and coupled to the building automation system, and wherein the at least one data point is grouped in the set of data points.

4. The method of claim 2, wherein at least one data point represents an operational status of a building component within the building and coupled to the building automation system, and wherein the at least one data point is grouped in the set of data points.

5. The method of claim 1, wherein the component model represents a generic physical component used in a HVAC system.

6. The method of claim 1, wherein the component model represents a specific physical component of a HVAC system.

7. The method of claim 1, wherein the formula comprises a data point is not in the set of data points, and method further comprising:
calculating a virtual data point using at least one data point from the set of data points; and
evaluating the formula using the virtual data point.

8. The method of claim 1, wherein the formula comprises a Boolean data point representing a system condition is not in the set of data points, and the method further comprising:
determining a Boolean value representing the presence of the system or output condition using at least one data point from the set of data points; and
evaluating the formula using the Boolean value.

9. The method of claim 1, further comprising calculating at least one of a cost and an energy usage associated with the environmental condition.

10. The method of claim 1, wherein the environmental condition comprises at least one of a hardware failure of a physical component of the building, a software failure of the building automation system, or an inefficient control sequence utilized by the building automation system that controls the physical component.

11. The method of claim 1, further comprising receiving a third party set of data points by retrieving information relevant to the building from a third party.

12. A system for analyzing environmental data from a building comprising:
a computing device including a processor coupled to a system memory, the system memory storing instructions for execution on the processor, the instructions configured to cause the processor to:
receive a set of data points from a building automation system operating on the building, wherein each data point corresponds to an environmental condition of the building;
store the set of data points in a database operating in the system memory;
associate each data point with variable representing a type of information conveyed by the data point and storing;
map at least one variable to a component model stored in a model library stored in the system memory, the component model representing a physical component of the building;
select a formula for evaluating the operation of the physical component represented by the component model from a formula library stored in the system memory; and
diagnose an environmental condition by evaluating the formula using the data points.

13. The system of claim 12, wherein the set of data points is divided into at least one group of data points according to a relationship between at least two data points, and wherein a group of data points is associated with a group of variables and the group of variables is matched to a single component model.

14. The system of claim 13, wherein at least one data point is generated by a sensor component operating within the building and coupled to the building automation system, and wherein the at least one data point is grouped in the set of data points.

15. The system of claim 13, wherein at least one data point represents an operational status of a building component within the building and coupled to the building automation system, and wherein the at least one data point is grouped in the set of data points.

16. The system of claim 12, wherein the component model represents a generic physical component used in a HVAC system.

17. The system of claim 12, wherein the component model represents a specific component of a HVAC system.

18. The system of claim 12, wherein the formula comprises at least one required data point not in the set of data points, and wherein the instructions configured to cause the processor to:
calculate a virtual data point using at least one data point from the set of data points; and
evaluate the formula using the virtual data point.

19. The system of claim 12, wherein the formula comprises at least one required Boolean data point representing a system condition not in the set of data points, and wherein the instructions configured to cause the processor to:
determining a Boolean value representing the presence of the system or output condition using at least one data point from the set of data points; and
evaluating the formula using the Boolean value.

20. The system of claim 12, wherein the instructions are further configured to cause the processor to calculate at least one of a cost and an energy usage associated with the environmental condition.

21. The method of claim 12, wherein the environmental condition comprises at least one of a hardware failure, a software failure, an inefficient control sequence, or a poor operating strategy.

22. The system of claim 12, wherein the instructions are further configured to cause the processor to receive a third party set of data points by retrieving information relevant to the building from a third party.

23. A method of analyzing a dataset comprising:
receiving a set of data points from a building automation system operation on the building, wherein each data point corresponds to an environmental status of the building and wherein the set of data points is divided into at least one group of data points according to a relationship between at least a first data point and a second data; and
associating each data point with variable representing a type of information conveyed by the data point, wherein a group of variables is formed for each group of data points;
mapping at least one variable to a component model, wherein the component model represents a physical component of the building, and wherein groups of variables are mapped to a single component model;
selecting a formula for evaluating the operation of the physical component represented by the component model; and
diagnosing an environmental condition by evaluating the formula using the data points.

24. The method of claim 23, wherein at least one data point is generated by a sensor component operating within the building and coupled to the building automation system, and wherein the at least one data point is grouped.

25. The method of claim 23, further comprising calculating a cost associated with each of the at least one building automation system problems and displaying the at least one building automation system problem according to the cost.
